(19) United States
(12) Patent Application Publication
(10) Pub. No.: US 2003/0106408 A1
(43) Pub. Date: Jun. 12, 2003

(54) Support structure for a stringed instrument

(76) Inventors: Uwe Florath, Kellokoski (FI); Kauko Liikanen, Helsinki (FI)

Correspondence Address: Finn T Simmensen, Kleinberg & Lerner, Suite 1080, 2049 Century Park East, Los Angeles, CA, 90067, US

(21) Appl. No.: 10/239,126

(22) PCT Filed: Mar. 23, 2001
(86) PCT No.: PCT/FI01/00290

(30) Foreign Application Priority Data
Mar. 24, 2000 (FI) 20000689

(51) Int. Cl. G10D 3/00

(52) U.S. Cl. 84/291

(57) ABSTRACT

The invention relates to a support structure for stiffening one or more vibrating surfaces (1) of an acoustic stringed instrument. The support structure is formed by at least one sheet-like piece (3) which is supported at least partly at a distance from the surface (1) to be stiffened by means of one or more formed pieces (4) arranged between the sheet-like piece (3) and the surface (1) to be stiffened. The entity formed by the sheet-like piece (3) and the surface (1) to be stiffened together is the shape of a lens thinning towards the edges in cross-section.

The invention relates to a support structure for stiffening one or more vibrating surfaces of an acoustic stringed instrument.

With various acoustic stringed instruments, the aim is to make the vibrating surfaces of the instrument, especially the cover and/or the back, as thin and as easily resonating elements as possible. But then again, certain stiffness requirements are set for this type of elements. The cover, especially, should be sufficiently stiff and firm to withstand the strain caused by the strings.

In order for the instrument to produce an acoustic sound of sufficient volume and to be sensitively sounding, the mass of the vibrating part should be as small as possible. An even, pure tone over the instrument's entire range of sound requires careful control of the vibrating parts, especially of the resonances of the cover and the back.

Extremely contradictory requirements are thus set for the vibrating surfaces. On the one hand they should be easily resonating, and on the other stiff. Attempts have been made to solve this problem by using different kinds of support laths at suitable points.

By using support laths, it has been possible to make instruments meeting extremely high standards. However, due to the excessive mass amounting from them, not enough laths can be included to be able to tune the tone of the instrument over the entire range of sound in the best possible way.

The object of the invention is to eliminate these disadvantages.

To achieve this object, the support structure relating to the invention is characterised in that the support structure is formed by at least one sheet-like piece which is supported at least partly at a distance from the surface to be stiffened by means of one or more formed pieces arranged between the sheet-like piece and the surface to be stiffened, and that the entity formed by the sheet-like piece and the surface to be stiffened together is the shape of a lens thinning towards the edges in cross-section.

By means of the invention is achieved a lighter structure which is well controlled as concerns resonance, whereby the sound volume of the instrument increases and the purity of tone improves. Due to the smoother inner surfaces, the sound box functions more efficiently, thus also improving the quality of the tone.

It should be noted in particular, that when using the support structure relating to the invention, the actual surface to be stiffened can be made thinner than conventional structures.

Further preferable developments of the invention are disclosed in the dependent claims.

The invention is described in greater detail in the following, with reference to the appended drawings, in which

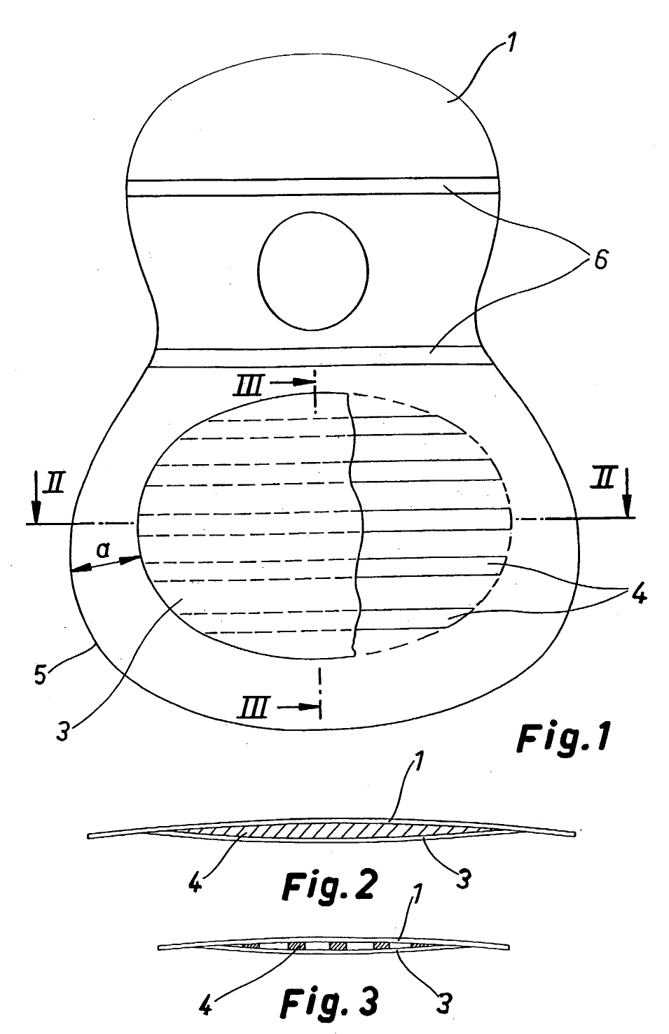

FIG. 1 shows diagrammatically the cover of the guitar as seen on the inside of the sound box and equipped with the support structure relating to the invention.

FIG. 2 shows a section of FIG. 1 along line II-II.

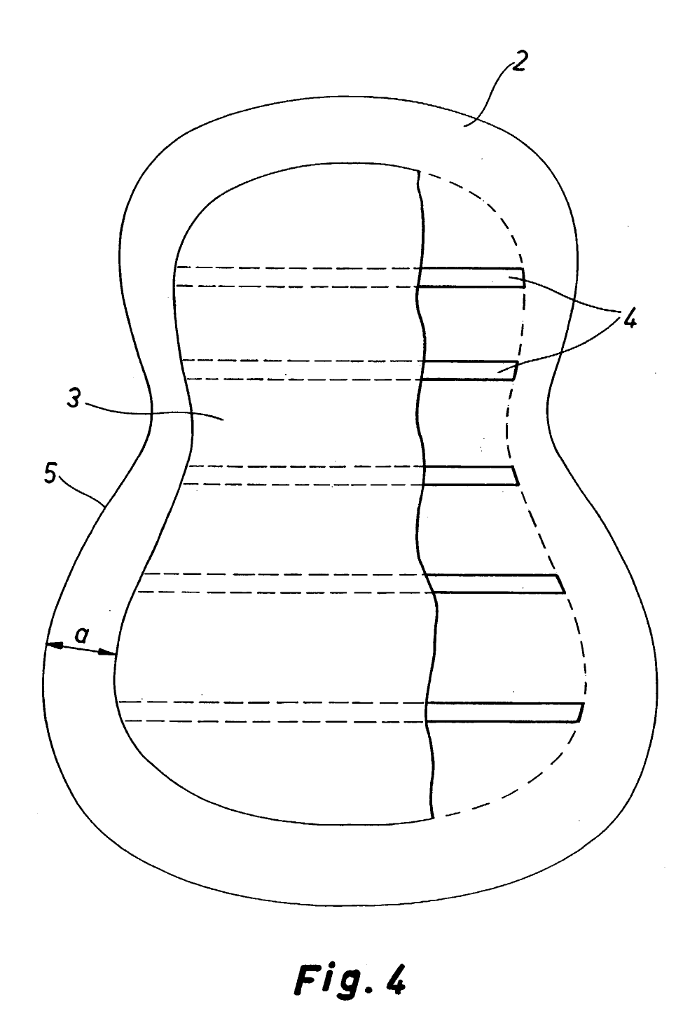

FIG. 3 shows a section of FIG. 1 along line III-III.

FIG. 4 shows diagrammatically the back of the guitar as seen on the inside of the sound box and equipped with the support structure relating to the invention.

FIG. 1 shows diagrammatically the cover 1 of the guitar as seen on the inside of the sound box and equipped with the support structure relating to the invention. The support structure is formed by at least one sheet-like piece 3 which is supported at least partly at a distance from the surface (cover) 1 to be stiffened. To achieve a suitable stiffness, one or more formed pieces 4 are arranged between the sheet-like piece 3 and the surface 1 to be stiffened. In the example shown in the drawing, laths 4 act as formed pieces. A formed piece 4 may be made of, for example, wood or of a synthetic material.

The entity formed by the sheet-like piece 3 and the surface 1 to be stiffened together is the shape of a lens thinning towards the edges in cross-section, as seen best in FIGS. 2 and 3. In that case, the sheet-like piece 3 to be attached to the surface 1 to be stiffened will not form edges protruding sharply from the surface 1, but instead the sheet-like piece 3 and the surface 1 to be stiffened are joined with each other smoothly.

The sheet-like piece 3 is attached on its edges and by means of the laths 4 firmly to the surface 1 being stiffened.

It should be emphasised in particular that the sheet-like piece 3 does not have to cover the formed piece 4 entirely, especially when the formed piece already forms a uniform piece as such, but instead there may be several spaced apart sheet-like pieces 3 on top of the formed piece 4. In such a case, the sheet-like pieces 3 may be in the shape of, for example, lath-like pieces of even width and relatively thin in thickness.

The sheet-like piece 3 is smaller than the surface 1 to be stiffened. The sheet-like piece 3 is fitted in such a way with respect to the surface 1 to be stiffened that the sheet-like piece 3 is at all points at a distance a from the outer edge 5 of the surface 1 to be stiffened. The magnitude of distance a may be different at different points. The sheet-like piece 3 does not, therefore, have to be symmetrical with the surface 1 to be stiffened, nor does it have to be located symmetrically with respect to the surface 1 being stiffened.

In principle, the larger the sheet-like piece 3 is dimensioned with respect to the surface 1 being stiffened, the stiffer the surface 1 to be stiffened will be. Stiffness may obviously also be increased by increasing the thickness of the laths 4.

The sheet-like piece 3 is preferably attached to the surface 1 to be stiffened on the inside of the sound box. It is, however, also possible to arrange this in such a way that the sheet-like piece 3 is fitted on the visible side of the surface 1 to be stiffened.

The sheet-like piece 3 and the surface 1 to be stiffened can be made of different materials, for example, different kinds of wood, in which case the direction of the grain may be different in the sheet-like piece 3 and the surface 1 to be stiffened. The quality of the tone can thus be tuned by using different materials in the parts 1, 3. The material used for the parts 1, 3 may naturally also be the same in both.

If necessary, one or more support laths 6 may in addition be attached to the surface 1 to be stiffened in order to obtain an optimal structure. The support lath 6 may be completely outside the sheet-like piece 3, but it may also be partly or completely on top of the sheet-like piece 3.

FIG. 4 further shows diagrammatically the back of the guitar equipped with the support structure relating to the invention. Here, the sheet-like piece 3 is considerably larger than on the cover shown in FIG. 1. The size of the sheet-like piece 3 and the number of pieces 3 can, however, be selected in accordance with the respective structure of the stringed instrument in question.

Although the invention has been described above only with reference to a guitar, the support structure relating to the invention is also applicable to other acoustic stringed instruments, such as mandolins, zithers, pianos, etc.

1. A support structure for stiffening one or more vibrating surfaces (1, 2) of an acoustic stringed instrument, characterised in that the support structure is formed by at least one sheet-like piece (3) which is supported at least partly at a distance from the surface (1, 2) to be stiffened by means of one or more formed pieces (4) arranged between the sheet-like piece (3) and the surface (1, 2) to be stiffened, and that the entity formed by the sheet-like piece (3) and the surface (1, 2) to be stiffened together is the shape of a lens thinning towards the edges in cross-section.

2. A support structure as claimed in claim 1, characterised in that between the sheet-like piece (3) and the surface (1, 2) to be stiffened is arranged a number of laths (4).

3. A support structure as claimed in claim 1, characterised in that the sheet-like piece (3) is attached firmly to the surface (1, 2) to be stiffened.

4. A support structure as claimed in claim 1, characterised in that the sheet-like piece (3) is smaller than the surface (1, 2) to be stiffened.

5. A support structure as claimed in claim 4, characterised in that the sheet-like piece (3) is fitted in such a way with respect to the surface (1, 2) to be stiffened that the sheet-like piece (3) is at all points at a distance (a) from the outer edge (5) of the surface (1, 2) to be stiffened.

6. A support structure as claimed in claim 1, characterised in that the sheet-like piece (3) is attached to the surface (1, 2) to be stiffened on the inside of the sound box.

7. A support structure as claimed in claim 1, characterised in that the sheet-like piece (3) and the surface (1, 2) to be stiffened are made of different materials.

8. A support structure as claimed in claim 1, characterised in that one or more support laths (6) are attached to the surface (1,2) to be stiffened.
